(19) United States
(12) Patent Application Publication
(10) Pub. No.: US 2026/0217565 A1
(43) Pub. Date: Jul. 30, 2026

(54) PRECURSOR OF POSITIVE ELECTRODE ACTIVE MATERIAL

(71) Applicant: TOYOTA JIDOSHA KABUSHIKI KAISHA, Toyota-shi (JP)

(72) Inventors: Kenji Yokoe, Toyota-shi (JP); Momoko Procter, Seto-shi (JP)

(73) Assignee: TOYOTA JIDOSHA KABUSHIKI KAISHA, Toyota-shi (JP)

(21) Appl. No.: 19/439,776

(22) Filed: Jan. 5, 2026

(30) Foreign Application Priority Data
Jan. 24, 2025 (JP) 2025-010254

(51) Int. Cl. C01G 53/84

(52) U.S. Cl. CPC C01G 53/84; C01P 2002/72; C01P 2006/40

(57) ABSTRACT

A precursor of a positive electrode active material, in which the precursor is a particle of a nickel cobalt manganese composite hydroxide, and in an XRD analysis, the precursor has a peak A and a peak B in which a (100) plane attributed to a space group R3-m is split into two peaks.

### CROSS-REFERENCE TO RELATED APPLICATION

This application claims priority to Japanese Patent Application No. 2025-010254 filed on Jan. 24, 2025. The disclosure of the above-identified application, including the specification, drawings, and claims, is incorporated by reference herein in its entirety.

### BACKGROUND

### 1. Technical Field

The present disclosure relates to a precursor of a positive electrode active material.

### 2. Description of Related Art

Various techniques have been proposed for a positive electrode active material as disclosed in Japanese Unexamined Patent Application Publication No. 2021-24764 (JP 2021-24764 A) and Japanese Unexamined Patent Application Publication No. 2014-139119 (JP 2014-139119 A).

### SUMMARY

In the related art, various positive electrode active materials have been proposed in order to obtain a positive electrode having high battery characteristics such as high cycle characteristics and high output characteristics.

For example, JP 2021-24764 A discloses a nickel composite hydroxide in which, in a measurement of a pore size distribution by a nitrogen adsorption method, an average diameter of pores is 50 angstroms or more and 60 angstroms or less, and an integrated intensity ratio of a diffraction peak appearing in a range of 2θ=51.9°±1.0° to a diffraction peak appearing in a range of 2θ=19.1°±1.0° in powder X-ray diffraction using a CuKα ray is 0.40 or more and 0.50 or less. A composition of the nickel composite hydroxide of JP 2021-24764 A is represented by a molar ratio of Ni:Co:Mn:M of 1-x-y-z:x:y:z. 0<x≤0.15, 0<y≤0.15, and 0≤z≤0.05, and M means one or more additive elements selected from the group consisting of Al, Fe, Ti, and Zr.

The nickel composite hydroxide described in JP 2021-24764 A is a precursor of a positive electrode active material, and can be used as a positive electrode active material by being fired with a lithium compound. However, the positive electrode active material obtained from the nickel composite hydroxide of JP 2021-24764 A has room for improvement in a capacity retention rate. The reason is that, in a case where the charging and discharging are repeated, cation mixing in which lithium ions and other metal ions are exchanged occurs in the positive electrode active material, which causes a decrease in capacity.

The present disclosure has been made in view of the circumstances, and a main object thereof is to provide a precursor of a positive electrode active material capable of obtaining a positive electrode active material having an excellent capacity retention rate.

That is, the present disclosure includes the following aspects.

<1> A precursor of a positive electrode active material, in which the precursor is a particle of a nickel cobalt manganese composite hydroxide, and in an XRD analysis, the precursor has a peak A and a peak B resulting from splitting a peak of a (100) plane attributed to a space group R3-m into two peaks.

<2> The precursor according to <1>, in which
an angle difference C of diffraction angles at peak tops of the peak A and the peak B is 0.31° or more and 0.68° or less, and
a ratio D (following expression) of an integrated intensity I_{B} of the peak B to a total of an integrated intensity I_{A} of the peak A and the integrated intensity I_{B} of the peak B, the integrated intensity I_{A} and the integrated intensity I_{B} being obtained by performing fitting with a Gaussian function and a Lorentzian function for the peak A and the peak B, is more than 0 and 0.63 or less.

$$Ratio D = {I}_{B} / ( {I}_{A} + {I}_{B} )$$

According to the present disclosure, it is possible to provide a precursor of a positive electrode active material capable of obtaining a positive electrode active material having an excellent capacity retention rate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an example (precursor of Example 4) of an XRD diffraction pattern obtained by XRD analysis of the precursor of the present disclosure;

FIG. 2 is a diagram in which a range surrounded by a broken line quadrangle in FIG. 1 is enlarged; and

FIG. 3 is a graph in which fitting with a Gaussian function and a Lorentzian function is performed on the XRD diffraction pattern in FIG. 2.

### DETAILED DESCRIPTION OF EMBODIMENTS

Embodiments according to the present disclosure will be described below. It is noted that matters other than the matters particularly mentioned in the present specification, which are necessary for implementing the present disclosure, can be understood as design matters of those skilled in the art based on the related art in the field. The matters other than the matters particularly mentioned in the present specification, which are necessary for implementing the present disclosure, are, for example, a general configuration and a production process of a positive electrode active material and a precursor thereof that do not characterize the present disclosure. The present disclosure can be conducted based on the contents disclosed in the present specification and the common general technical knowledge in the field.

In the present disclosure, the precursor of a positive electrode active material is a particle of a nickel cobalt manganese composite hydroxide. In an XRD analysis, the precursor has a peak A and a peak B in which a (100) plane attributed to a space group R3-m is split into two peaks.

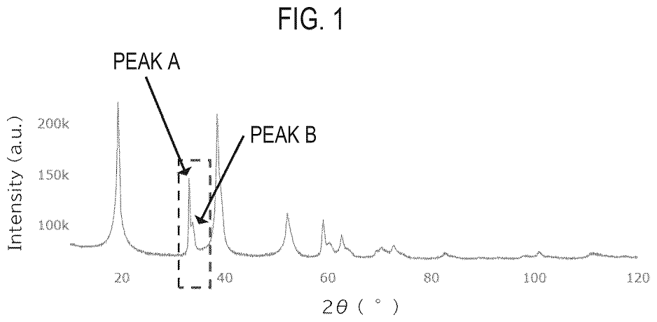

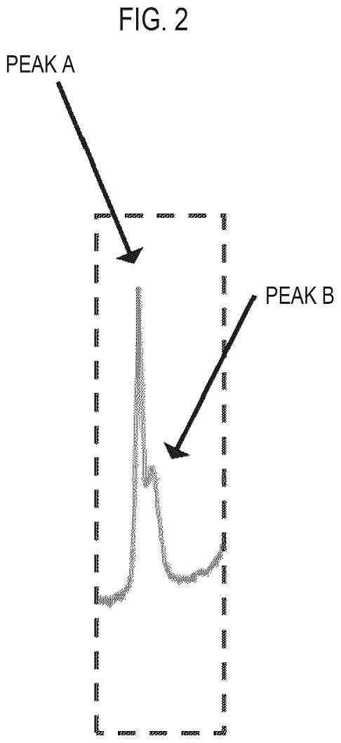

FIG. 1 shows an example (precursor of Example 4) of an XRD diffraction pattern obtained by X-ray diffraction (XRD) analysis of the precursor of the present disclosure. In addition, FIG. 2 is a diagram in which a range surrounded by a broken line quadrangle in FIG. 1 is enlarged. A peak of a (100) plane attributed to a space group R3-m is present in a range surrounded by a broken line quadrangle in FIGS. 1 and 2. As can be seen from FIGS. 1 and 2, in the precursor of the present disclosure, peak splitting is observed in a range surrounded by a broken line quadrangle. That is, the precursor of the present disclosure has a peak A and a peak B in which a (100) plane attributed to a space group R3-m is split into two peaks.

The peak A having a relatively small diffraction angle (2θ) of the two peaks is a peak derived from a region (Mn-poor region) in which a compositional ratio of nickel (Ni) is relatively high and a compositional ratio of manganese (Mn) is relatively low. On the other hand, the peak B having a relatively large diffraction angle (2θ) is a peak derived from a region (Mn-rich region) in which a compositional ratio of manganese is relatively high and a compositional ratio of nickel is relatively low.

That is, the precursor of a positive electrode active material of the present disclosure is a nickel cobalt manganese composite hydroxide particle having an Mn-poor region and an Mn-rich region. In addition, since the precursor of the present disclosure has a peak attributed to a space group R3-m, the precursor has a structure (layered rock salt structure) attributed to R3-m.

In a case where a nickel cobalt manganese composite hydroxide and a lithium compound are fired, a lithium nickel cobalt manganese composite oxide of a positive electrode active material is obtained. It is known that, in a case where the charging and discharging are repeated, in the positive electrode active material, cation mixing in which lithium ions and metal ions such as nickel are exchanged occurs in the positive electrode active material, which causes a decrease in capacity. The reason is that, in the lithium nickel cobalt manganese composite oxide having a layered structure attributed to a space group R3-m, in a case where nickel is present in a divalent state (Ni²⁺), since an ionic radius is close to that of lithium, a proportion of nickel entering a lithium site increases. The divalent nickel (Ni²⁺) is generated in a case of coexistence with tetravalent manganese (Mn⁴⁺) rather than nickel alone.

As described above, the precursor of a positive electrode active material of the present disclosure is a particle of a nickel cobalt manganese composite hydroxide, and has an Mn-poor region and an Mn-rich region. In the Mn-poor region, a compositional ratio of nickel (Ni) is relatively high, and a compositional ratio of manganese (Mn) is relatively low. In the Mn-rich region, a compositional ratio of manganese is relatively high, and a compositional ratio of nickel is relatively low. In the precursor of the present disclosure, in the Mn-poor region, a proportion of nickel (Ni³⁺) present in a trivalent state increases, and a proportion of nickel (Ni²⁺) present in a divalent state decreases, so that cation mixing of nickel is suppressed. In addition, in the Mn-rich region, a proportion of nickel in contact with manganese is relatively small, and a proportion of nickel (Ni²⁺) present in a divalent state is small, so that cation mixing of nickel is suppressed.

As described above, by using the precursor of the present disclosure, it is possible to obtain a positive electrode active material in which the occurrence of cation mixing is suppressed. That is, according to the present disclosure, it is possible to provide a positive electrode active material having an excellent capacity retention rate.

The precursor of the present disclosure is a particle of a nickel cobalt manganese composite hydroxide.

In the present disclosure, the particle may be a primary particle or a secondary particle in which a plurality of primary particles is aggregated. The particle shape is not particularly limited, and examples thereof include a substantially spherical shape and a substantially elliptical shape. The size of the particle is not particularly limited. The size of the particle can be obtained, for example, by measuring sizes of cross sections of a plurality of particles in a transmission electron microscope (TEM) image or a scanning electron microscope (SEM) image and calculating an average value thereof.

In addition, in the present disclosure, the nickel cobalt manganese composite hydroxide is a composite hydroxide containing nickel (Ni), cobalt (Co), and manganese (Mn) as essential metal species. In addition, in the present disclosure, the nickel cobalt manganese composite hydroxide may contain other metal species other than nickel, cobalt, and manganese. The other metal species may be, for example, at least one selected from the group consisting of Zr, Mo, Mg, Ca, Na, Fe, Cr, Zn, Si, Sn, and Ag. In the nickel cobalt manganese composite hydroxide, proportions (molar ratios) of nickel, cobalt, and manganese are not particularly limited. The molar ratio of the nickel cobalt manganese composite hydroxide may be as follows. Ni/NiCoMn may be 0.5 or more and less than 1.0, Co/NiCoMn may be more than 0 and 0.3 or less, and Mn/NiCoMn may be more than 0 and 0.3 or less.

The XRD analysis can be performed, for example, by powder XRD measurement using a known XRD analysis device such as Rigaku SmartLab II. Specific analysis conditions include, for example, the following conditions.

### XRD Analysis Conditions

Analysis method: wide-angle method
Measurement angle: 10° to 120°
Tube: Cu
Optical system: Kα
Voltage: 45 kV
Current: 200 mA
Measurement method: continuous method
Step width: 0.02°
Scan rate: 2°/min
IS: ½
RS: 20 mm
Detection mode: one-dimensional

In the XRD analysis of the precursor of the present disclosure, a splitting pattern of the peak A and the peak B is not particularly limited.

For example, an angle difference C of diffraction angles at peak tops of the peak A and the peak B in which a (100) plane attributed to a space group R3-m is split into two peaks may be 0.31° or more and 0.68° or less.

The peak of the (100) plane attributed to the space group R3-m may be a peak in which a diffraction angle (2θ) appearing in a range of 33.30°+2.00°. Here, the diffraction angle (2θ_{A}) at the peak top of the peak A and the diffraction angle (2θ_{B}) at the peak top of the peak B are calculated as follows. The XRD pattern obtained by the XRD analysis is subjected to background processing by polynomial approximation, and the one-dimensional data is differentiated to obtain a point intersecting with 0 as a peak top (peak top of the peak A and peak top of the peak B). Then, the diffraction angle is set as the diffraction angle (2θ_{A}, 2θ_{B}) of each peak.

An angle difference C (°, degree) between the diffraction angle (2θ_{A}) at the peak top of the peak A and the diffraction angle (2θ_{B}) at the peak top of the peak B is calculated by the following expression.

$$C = 2 {θ}_{B} - 2 {θ}_{A}$$

In addition, a ratio D (following expression) of an integrated intensity I_{B} of the peak B to a total of an integrated intensity I_{A} of the peak A and an integrated intensity I_{B} of the peak B, the integrated intensities I_{A} and I_{B} being obtained by performing fitting with a Gaussian function and a Lorentzian function for the peak A and the peak B, may be more than 0 and 0.63 or less. The ratio D may be 0.06 or more and 0.63 or less.

$$Ratio D = {I}_{B} / ( {I}_{A} + {I}_{B} )$$

The integrated intensity I_{A} of the peak A and the integrated intensity I_{B} of the peak B, which are obtained by performing fitting with a Gaussian function and a Lorentzian function, can be calculated as follows. It is noted that the integrated intensity I_{A} of the peak A obtained by performing fitting with a Gaussian function and a Lorentzian function may be simply referred to as “integrated intensity I_{A} of peak A”. The integrated intensity I_{B} of the peak B obtained by performing fitting with a Gaussian function and a Lorentzian function may be simply referred to as “integrated intensity I_{B} of peak B”. First, the XRD diffraction pattern obtained by the XRD analysis is subjected to background processing by polynomial approximation, and the one-dimensional data is differentiated to obtain a point intersecting with 0 as a peak top (peak top of the peak A and peak top of the peak B). Next, a combined function of the Gaussian function and the Lorentzian function represented by the following expression is set as one peak, and fitting is performed on the two peaks of the peak A and the peak B to calculate the integrated intensity (I_{A}, I_{B}) of each peak, in other words, the integrated intensity area.

$$Combined function = ( Gaussian function ) * α + ( Lorentzian function ) * ( 1 - α )$$

In the expression, α means a mixing ratio of the function, and may be appropriately set.

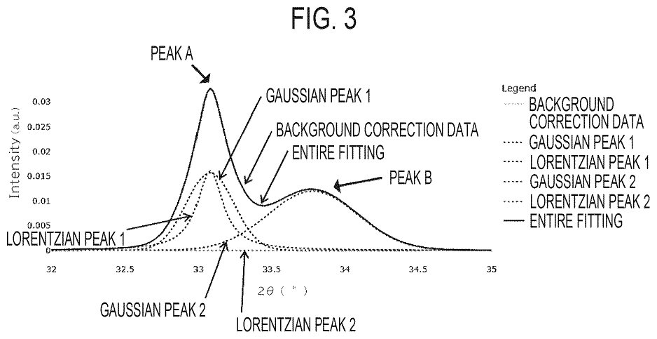

FIG. 3 shows a graph in which the XRD diffraction pattern in FIG. 2 is subjected to fitting with a Gaussian function and a Lorentzian function. In FIG. 3, the integrated intensity (I_{A}, I_{B}) can be calculated from an area formed by a curve based on a curve displayed as “entire fitting”.

Using the integrated intensity I_{A} of the peak A and the integrated intensity I_{B} of the peak B calculated as described above, a ratio D of the integrated intensity I_{B} to the total of the integrated intensity I_{A} and the integrated intensity I_{B} can be calculated.

In the present disclosure, the angle difference C of diffraction angles at peak tops of the peak A and the peak B may be 0.31° or more and 0.68° or less. The ratio D may be more than 0 and 0.63 or less. The ratio D is a ratio of the integrated intensity I_{B} of the peak B to the total of the integrated intensity I_{A} of the peak A and the integrated intensity I_{B} of the peak B, the integrated intensities I_{A} and I_{B} being obtained by performing fitting with a Gaussian function and a Lorentzian function for the peak A and the peak B.

A method for producing the precursor of the positive electrode active material according to the present disclosure is not particularly limited, and examples thereof include the following method.

First, an NiCo aqueous solution in which a water-soluble nickel source (nickel compound) and a water-soluble cobalt source (cobalt compound) are dissolved in ion exchange water, and an Mn aqueous solution in which a water-soluble manganese source (manganese compound) is dissolved in ion exchange water are prepared. In this case, the amount of nickel and cobalt contained in the NiCo aqueous solution and the amount of manganese contained in the Mn aqueous solution are set such that, in a case where the NiCo aqueous solution and the Mn aqueous solution are mixed with each other, a proportion (mol %) of nickel, cobalt, and manganese with respect to the total amount of nickel, cobalt, and manganese is typically equal to a proportion (mol %) of nickel, cobalt, and manganese constituting the nickel cobalt manganese composite hydroxide. The water-soluble metal compound is not particularly limited, and examples thereof include sulfates. The concentrations of the NiCo aqueous solution and the Mn aqueous solution may be appropriately set.

Next, an NH₃ aqueous solution (ammonium ion supply source) is added to the reaction container in a constant amount, and the inside of the reaction container is replaced with nitrogen and set to a non-oxidizing atmosphere while stirring with a stirrer or the like. Subsequently, a sodium hydroxide aqueous solution is added to the reaction container, and the NiCo aqueous solution, the Mn aqueous solution, and the NH₃ aqueous solution are added dropwise to the reaction container while maintaining the pH at an alkaline level (for example, pH 12). The dropping speed of each aqueous solution may be appropriately set. The reaction temperature is not particularly limited, and may be, for example, 60° C. After the reaction is completed, a drying treatment is performed. The drying treatment can be performed, for example, in an inert gas atmosphere at 120° C. for 1 hour.

The precursor of a positive electrode active material according to the present disclosure can be used as a positive electrode active material of a battery such as a lithium ion battery, for example, by being converted into a lithium nickel cobalt manganese composite oxide.

The lithium nickel cobalt manganese composite oxide can be produced from the precursor of the present disclosure by, for example, the following method. That is, a method of mixing the nickel cobalt manganese composite hydroxide, which is the precursor of the present disclosure, with a lithium compound serving as a lithium source and firing the obtained mixture.

Examples of the lithium compound include at least one selected from lithium carbonate, lithium nitrate, lithium acetate, lithium hydroxide, lithium oxide, and lithium chloride.

A proportion of the lithium compound and the precursor in the mixture is typically set such that a proportion (mol %) of lithium and each of the other metal species to the total amount of lithium and the metal species contained in the precursor in the positive electrode active material, which is the target substance, is equal to a proportion (mol %) of lithium and each of the other metal species in the mixture. The mixing method is not particularly limited, and a known method can be adopted.

For example, the obtained mixture can be fired at 700° C. to 950° C. for 8 hours to 10 hours to obtain a lithium nickel cobalt manganese composite oxide. A known firing furnace such as a muffle furnace can be used for the firing.

It is considered that the positive electrode active material obtained by firing the precursor according to the present disclosure is usually composed of single crystal particles. Here, the single crystal particle is a single particle that does not constitute a secondary particle, and means a particle consisting of substantially a single crystal. The fact that the particle is a single crystal particle can be confirmed from the fact that a grain boundary cannot be confirmed in the SEM image.

The precursor of the positive electrode active material provided by the present disclosure can be used as, for example, a precursor of a positive electrode active material constituting a positive electrode of a battery (a lithium ion battery or the like). That is, in the present disclosure, it is possible to provide a battery in which a positive electrode, an electrolyte layer, and a negative electrode are laminated in this order, in which the positive electrode contains a positive electrode active material obtained from the precursor according to the present disclosure.

Hereinafter, the battery will be described.

The positive electrode has a positive electrode layer, and further has a positive electrode collector as necessary.

The positive electrode layer is a layer containing at least a positive electrode active material. The positive electrode active material may contain only the positive electrode active material obtained from the precursor according to the present disclosure, or may further contain other active materials. A content of the positive electrode active material in the positive electrode layer is not particularly limited, and may be, for example, 20% by mass to 80% by mass. The positive electrode layer may contain at least one of an electrolyte, a conductive material, or a binder as necessary.

Examples of the electrolyte include a solid electrolyte. The solid electrolyte may be an inorganic solid electrolyte such as a sulfide solid electrolyte, a halide solid electrolyte, an oxide solid electrolyte, or a complex hydride solid electrolyte, or may be an organic solid electrolyte such as a gel electrolyte. A proportion of the solid electrolyte in the positive electrode layer may be, for example, 10% by mass to 60% by mass.

Examples of the conductive material include a carbon material, metal particles, and a conductive polymer. Examples of the carbon material include particulate carbon materials such as acetylene black (AB) and Ketjen black (KB). In addition, examples of the carbon material include fibrous carbon materials such as vapor-grown carbon fiber (VGCF), carbon nanotube (CNT), and carbon nanofiber (CNF). A proportion of the conductive material in the positive electrode layer may be, for example, 0.1% by mass to 5% by mass. Examples of the binder include styrene-butadiene rubber (SBR), acrylonitrile-butadiene rubber (NBR), butadiene rubber (BR), and polyvinylidene fluoride (PVDF). Further, examples of the binder include polytetrafluoroethylene (PTFE), styrene-isoprene-styrene block copolymer (SIS), and ethylene-propylene-diene copolymer (EPDM). A proportion of the binder in the positive electrode layer may be, for example, 0.5% by mass to 5% by mass. Examples of a material of the positive electrode collector include SUS, Cr, Au, Pt, Zn, aluminum, copper, nickel, iron, titanium, and carbon. A thickness of the positive electrode collector is, for example, 0.1 μm or more and 100 μm or less. A shape of the positive electrode collector may be a foil shape, a plate shape, or the like. A planar shape of the positive electrode collector is not particularly limited, and examples thereof include a circular shape, an elliptical shape, a rectangular shape, and any polygonal shape. The positive electrode collector may have a configuration in which a buffer layer, an elastic layer, or a positive temperature coefficient (PTC) thermistor layer is disposed on a surface thereof.

The negative electrode has a negative electrode layer, and further has a negative electrode collector as necessary.

The negative electrode layer is a layer containing at least a negative electrode active material. In addition, the negative electrode layer may contain at least one of an electrolyte, a conductive material, or a binder as necessary. Examples of the negative electrode active material of the lithium ion battery include a carbon material such as natural graphite, Li single body, and a Li alloy.

Examples of the electrolyte, the conductive material, and the binder used in the negative electrode layer include the same ones as those described in the positive electrode layer. Examples of a material of the negative electrode collector include SUS, aluminum, copper, nickel, iron, titanium, and carbon. A thickness of the negative electrode collector is, for example, 0.1 μm or more and 100 μm or less. A shape of the negative electrode collector may be a foil shape, a plate shape, or the like. A planar shape of the negative electrode collector is not particularly limited, and examples thereof include a circular shape, an elliptical shape, a rectangular shape, and any polygonal shape. The negative electrode collector may have a configuration in which a buffer layer, an elastic layer, or a PTC thermistor layer is disposed on a surface thereof.

The electrolyte layer is a layer provided between the positive electrode layer and the negative electrode layer, and contains at least an electrolyte. Examples of the electrolyte include an electrolytic solution in addition to the solid electrolyte described in the positive electrode layer.

As the electrolytic solution, an aqueous electrolytic solution, a non-aqueous electrolytic solution, or the like can be used. The electrolytic solutions may be used alone or in combination of two or more kinds thereof.

The solvent of the aqueous electrolytic solution contains water as a main component. That is, water may occupy 50 mol % or more, particularly 70 mol % or more, and further 90 mol % or more with respect to the total amount of the solvent (liquid component) constituting the electrolytic solution (100 mol %). On the other hand, an upper limit of the proportion of water in the solvent is not particularly limited.

The solvent contains water as a main component, but may contain a solvent other than water. Examples of the solvent other than water include one or more selected from ethers, carbonates, nitriles, alcohols, ketones, amines, amides, sulfur compounds, and hydrocarbons. The solvent other than water may be 50 mol % or less, particularly 30 mol % or less, and further 10 mol % or less with respect to the total amount of the solvent (liquid component) constituting the electrolytic solution (100 mol %).

The aqueous electrolytic solution contains an electrolyte. As the electrolyte for the aqueous electrolytic solution, a known electrolyte in the related art can be used. Examples of the electrolyte include a lithium salt, a nitrate, an acetate, and a sulfate of an imide acid compound. Specific examples of the electrolyte include lithium bis(fluorosulfonyl)imide (LiFSI), lithium bis(trifluoromethanesulfonyl)imide (LiTFSI), and the like. Further, specific examples of the electrolyte include lithium bis(pentafluoroethanesulfonyl)imide (LiBETI), lithium bis(nonafluorobutanesulfonyl)imide, and the like. Further, specific examples of the electrolyte include lithium nonafluoro-N-[(trifluoromethane) sulfonyl]butanesulfonylamide, lithium N,N-hexafluoro-1,3-disulfonylimide, and the like. Further, specific examples of the electrolyte include CH₃COOLi, LiPF₆, LiBF₄, Li₂SO₄, and LiNO₃.

A concentration of the electrolyte in the aqueous electrolytic solution can be appropriately set according to the characteristics of the battery to be obtained within a range not exceeding the saturation concentration of the electrolyte with respect to the solvent. The reason is that, in a case where a solid electrolyte remains in the aqueous electrolytic solution, the solid may hinder the battery reaction.

For example, in a case where LiTFSI is used as the electrolyte, the aqueous electrolytic solution may contain 1 mol or more, particularly 5 mol or more, and further 7.5 mol or more of LiTFSI per 1 kg of water. The upper limit thereof is not particularly limited, and may be, for example, 25 mol or less.

As the non-aqueous electrolytic solution, a solution containing a lithium salt and a non-aqueous solvent is usually used.

Examples of the lithium salt include inorganic lithium salts such as LiPF₆, LiBF₄, LiClO₄, and LiAsF₆. Further, examples of the lithium salt include organic lithium salts such as LiCF₃SO₃, LiN(SO₂CF₃)₂ (Li-TFSI), LiN(SO₂C₂F₅)₂, and LiC(SO₂CF₃)₃.

Examples of the non-aqueous solvent include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethyl sulfoxide (DMSO), and mixtures thereof. From the viewpoint of ensuring a high dielectric constant and a low viscosity, the non-aqueous solvent may be a mixture of a cyclic carbonate compound having a high dielectric constant and a high viscosity, such as EC, PC, and BC and a chain-like carbonate compound having a low dielectric constant and a low viscosity, such as DMC, DEC, and EMC. The non-aqueous solvent may be a mixture of EC and DEC. A concentration of the lithium salt in the non-aqueous electrolytic solution may be, for example, 0.3 M to 5 M.

The non-aqueous electrolytic solution may contain an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives thereof.

As the electrolyte layer, a separator which is impregnated with the electrolytic solution and prevents the contact between the positive electrode layer and the negative electrode layer may be used.

The material of the separator is not particularly limited as long as it is a porous film, and examples thereof include resins such as polyethylene (PE), polypropylene (PP), polyester, polyvinyl alcohol, cellulose, and polyamide. The material of the separator may be polyethylene or polypropylene among these. In addition, the separator may have a single layer structure or a multi-layer structure. Examples of the separator having a multi-layer structure include a separator having a two-layer structure of PE/PP, and a separator having a three-layer structure of PP/PE/PP or PE/PP/PE.

The separator may be a nonwoven fabric such as a resin nonwoven fabric or a glass fiber nonwoven fabric.

The battery may further have a constraint tool that applies a constraint pressure to the positive electrode layer, the electrolyte layer, and the negative electrode layer in the thickness direction. The constraint pressure may be, for example, 0.1 MPa to 100 MPa.

The type of the battery is not particularly limited, and is usually a battery in which a metal ion is conducted between the positive electrode layer and the negative electrode layer. Examples of such a battery include a lithium ion battery. In addition, the battery may be a primary battery or a secondary battery, and may be a secondary battery among these. It is because a secondary battery can be repeatedly charged and discharged and is useful, for example, as an in-vehicle battery.

The shape of the battery is not particularly limited, and may be, for example, a coin type, a cylindrical type, a square type, a sheet type, a button type, a flat type, or a laminated type.

Examples of the application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, the battery may be used as a power source for driving a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

### Examples 1 to 4

### Synthesis of Precursor of Positive Electrode Active Material

An NiCo aqueous solution in which NiSO₄ and CoSO₄ were dissolved in ion exchange water, and an Mn aqueous solution in which MnSO₄ was dissolved in ion exchange water were prepared. The Ni/Co/Mn ratio was set to 80/10/10 in terms of mol % in a case where the NiCo aqueous solution and the Mn aqueous solution were mixed with each other.

An NH₃ aqueous solution was added to the reaction container in a constant amount, and the inside of the reaction container was replaced with nitrogen while stirring with a stirrer. A NaOH aqueous solution was added to the reaction container, and the NiCo aqueous solution, the Mn aqueous solution, and the NH₃ aqueous solution were added dropwise to the reaction container while maintaining the pH at an alkaline level (pH=12). The reaction temperature was set to 60° C. After the reaction is completed, a drying treatment is performed at 120° C. for 1 hour in an inert gas atmosphere.

In Examples 1 to 4, each precursor was synthesized by changing the concentration and the dropping speed of the Mn aqueous solution.

### XRD Analysis of Precursor of Positive Electrode Active Material

The obtained precursors of Examples 1 to 4 were subjected to powder XRD analysis by a wide-angle method using an XRD analysis device (Rigaku SmartLab II). The analysis conditions were as follows. FIGS. 1 to 3 show the results of the XRD analysis of the precursor of Example 4.

### XRD Analysis Conditions

Measurement angle: 10° to 120°
Tube: Cu
Optical system: Kα
Voltage: 45 kV
Current: 200 mA
Measurement method: continuous method
Step width: 0.02°
Scan rate: 2°/min
IS: ½
RS: 20 mm
Detection mode: one-dimensional

As a result of the XRD analysis, it was confirmed that any of the precursors of Examples 1 to 4 had a peak A and a peak B in which a (100) plane attributed to a space group R3-m was split into two peaks. In addition, Table 1 shows diffraction angles (2θ_{A}, 2θ_{B}) at peak tops of the peak A and the peak B, an angle difference C of the diffraction angles, and a ratio D of an integrated intensity I_{B} of the peak B to a total of an integrated intensity I_{A} of the peak A and an integrated intensity I_{B} of the peak B, which were obtained by the XRD analysis.

### Comparative Example 1

### Synthesis of Precursor of Positive Electrode Active Material

NiSO₄, CoSO₄, and MnSO₄ were dissolved in ion exchange water to prepare a metal raw material aqueous solution. The Ni/Co/Mn ratio in the metal raw material aqueous solution was set to 80/10/10 in mol %. The concentration of the metal raw material aqueous solution (proportion of all raw materials to the metal raw material aqueous solution) was set to 1.5 mol %.

An NH₃ aqueous solution was added to the reaction container in a constant amount, and the inside of the reaction container was replaced with nitrogen while stirring with a stirrer. A NaOH aqueous solution was added to the reaction container, and the metal raw material aqueous solution and the NH₃ aqueous solution were added dropwise while maintaining the pH at an alkaline level (pH=12). The reaction temperature was set to 60° C., and the reaction time was set to 10 hours.

After the reaction is completed, a drying treatment is performed at 120° C. for 1 hour in an inert gas atmosphere.

### XRD Analysis of Precursor of Positive Electrode Active Material

In a case where the XRD analysis was performed in the same manner as in the examples, the peak of the (100) plane attributed to the space group R3-m was observed, but the splitting of the peak was not observed. The diffraction angle at the peak top of the peak was 33.30°.

In Table 1, in Comparative Example 1, since the splitting of the peak was not observed, the diffraction angles 2θ_{A} and 2θ_{B} were treated as 33.30°, and the angle difference C and the integrated intensity ratio D were set to zero.

### Synthesis of Positive Electrode Active Material

The precursor of each of Examples 1 to 4 and Comparative Example 1 synthesized above and a lithium compound (LiOH) as a lithium source were mixed in a mortar. The obtained mixture was fired at 950° C. for 10 hours in a firing furnace to synthesize positive electrode active materials (LiNi_{0.8}Co_{0.1}Mn_{0.1}O₂) of Examples 1 to 4 and Comparative Example 1.

### Production of Cell

Small laminated cells of Examples 1 to 4 and Comparative Example 1 were produced using each positive electrode active material of Examples 1 to 4 and Comparative Example 1.

Specifically, first, a positive electrode composite paste containing the positive electrode active material, acetylene black as a conductive material, and PVDF (4% by mass) as a binder was applied onto a surface of a metal foil as a positive electrode collector using a film applicator with a film thickness adjustment function. The film applicator with a film thickness adjustment function was manufactured by Allgrid Co., Ltd. Thereafter, the positive electrode was dried at 80° C. for 5 minutes in a dryer to produce a positive electrode having a positive electrode layer on the positive electrode collector.

On the other hand, a negative electrode composite paste containing natural graphite as a negative electrode active material was applied onto a surface of a metal foil as a negative electrode collector using a film applicator with a film thickness adjustment function (manufactured by Allgrid Co., Ltd.). Thereafter, the negative electrode was dried at 80° C. for 5 minutes in a dryer to produce a negative electrode having a negative electrode layer on the negative electrode collector.

As an electrolytic solution, a 1 M LiPF₆ solution containing LiPF₆ as an electrolyte, and ethylene carbonate (EC), dimethyl carbonate (DMC), and ethyl methyl carbonate (EMC) as a solvent at a ratio of EC/DMC/EMC=3/4/3 vol % was prepared.

The positive electrode, the separator, and the negative electrode were laminated, and the electrolytic solution was impregnated into the separator to produce small laminated cells of Examples 1 to 4 and Comparative Example 1.

### Evaluation of Cell

Discharge capacity measurements before and after a cycle test were performed on each of the produced small laminated cells. The cycle test was performed for 100 cycles under the following conditions.

### Discharge Capacity Measurement Conditions

C rate: 0.1 C
Measurement mode: CCCV discharging
Temperature: 25° C.

### Cycle Conditions

C rate: 0.3 C
Mode: CC charging/discharging
Temperature: 50° C.

Using the measured values of the discharge capacities before and after the cycle test, the capacity retention rate after the cycle test was calculated from the following expression.

$$Capacity retention rate ( \% ) = ( Discharge capacity after cycle test ) / ( Discharge capacity before cycle test ) \times 100$$

The capacity retention rates of Examples 1 to 4 were standardized with the capacity retention rate of Comparative Example 1 as a reference, from the following expression.

$$Standardized capacity retention rate = ( Capacity retention rate of each example ) / ( Capacity retention rate of Comparative Example 1 )$$

The results are shown in Table 1.

TABLE 1

| | | | | Integrated | Standardized |
|---|---|---|---|---|---|
| | | | Angle | intensity | capacity |
| | | | difference C | ratio D | retention |
| | 2θ_{A} | 2θ_{B} | (2θ_{A} − 2θ_{B}) | I_{B}/(I_{A} + I_{B}) | rate |
| Unit | [°] | [°] | [°] | — | — |
| Example 1 | 33.06 | 33.37 | 0.31 | 0.28 | 1.10 |
| Example 2 | 32.91 | 33.57 | 0.66 | 0.63 | 1.17 |
| Example 3 | 33.04 | 33.72 | 0.68 | 0.49 | 1.15 |
| Example 4 | 33.04 | 33.42 | 0.38 | 0.06 | 1.04 |
| Comparative | 33.30 | 33.30 | 0.00 | 0.00 | 1.00 |
| Example 1 | | | | | |

As shown in Table 1, in Examples 1 to 4 using the precursor in which the peak of the (100) plane attributed to the space group R3-m was split into two peaks, an improvement in the capacity retention rate was confirmed as compared with Comparative Example 1. In Comparative Example 1, a precursor in which the peak of the (100) plane attributed to the space group R3-m was not split was used. In the precursors of Examples 1 to 4, the angle difference C of the diffraction angles at the peak tops of the peak A and the peak B was 0.31° or more and 0.68° or less. In the precursors of Examples 1 to 4, the ratio D of the integrated intensity I_{B} of the peak B to the total of the integrated intensity I_{A} of the peak A and the integrated intensity I_{B} of the peak B was more than 0 and 0.63 or less. In addition, in Comparative Example 1 in which the metal raw material aqueous solution in which NiSO₄, CoSO₄, and MnSO₄ were dissolved in ion exchange water was added dropwise to the reaction container during the precursor synthesis, the peak of the (100) plane attributed to the space group R3-m was not split into two peaks. On the other hand, in Examples 1 to 4, the NiCo aqueous solution in which NiSO₄ and CoSO₄ were dissolved in ion exchange water, and the Mn aqueous solution in which MnSO₄ was dissolved in ion exchange water were added dropwise to the reaction container, respectively. In Examples 1 to 4, the peak of the (100) plane attributed to the space group R3-m was split into two peaks. From this, it can be seen that, in the nickel cobalt manganese composite hydroxide, the peak is split by adding the NiCo aqueous solution and the Mn aqueous solution dropwise to the reaction container, respectively.

What is claimed is:

1. A precursor of a positive electrode active material, wherein:
the precursor is a particle of a nickel cobalt manganese composite hydroxide; and
in an XRD analysis, the precursor has a peak A and a peak B resulting from splitting a peak of a (100) plane attributed to a space group R3-m into two peaks.

2. The precursor according to claim 1, wherein:
an angle difference C of diffraction angles at peak tops of the peak A and the peak B is 0.31° or more and 0.68° or less; and
a ratio D (following expression) of an integrated intensity I_{B} of the peak B to a total of an integrated intensity I_{A} of the peak A and the integrated intensity I_{B} of the peak B, the integrated intensity I_{A} and the integrated intensity I_{B} being obtained by performing fitting with a Gaussian function and a Lorentzian function for the peak A and the peak B, is more than 0 and 0.63 or less,
$$ratio D = {I}_{B} / ( {I}_{A} + {I}_{B} ) .$$
